(19) United States
(12) Patent Application Publication
(10) Pub. No.: US 2010/0020153 A1
(43) Pub. Date: Jan. 28, 2010

(54) IMAGE DRUM AND METHOD OF MANUFACTURING THE SAME

(75) Inventors: EUNG-YEOUL YOON, Suwon-si (KR); Kae-Dong Back, Hwaseong-si (KR); Jin-Seung Choi, Suwon-si (KR)

Correspondence Address: DLA PIPER LLP US, P. O. BOX 2758, RESTON, VA, 20195, US

(73) Assignee: SAMSUNG ELECTRONICS CO., LTD., SUWON-SI (KR)

(21) Appl. No.: 12/437,780

(22) Filed: May 8, 2009

(30) Foreign Application Priority Data
Jul. 23, 2008 (KR) 10-2008-0071898

(51) Int. Cl. B41J 2/385; B05D 3/10; B05D 5/12

(52) U.S. Cl. 347/111; 427/300; 427/443.1

(57) ABSTRACT

Provided are an image drum and a method of manufacturing the image drum. The image drum includes multiple ring electrodes arranged along a longitudinal direction of a drum body and on an outer circumferential surface of the drum body. The ring electrodes are separated from each other. Between the ring electrodes there are ring insulator molds. The image drum can be manufactured by patterning a seed layer on the outer surface of the drum body, forming multiple ring insulator molds on the seed layer, and depositing a conductive material between the ring insulator molds to form the ring electrodes.

### CROSS-REFERENCE TO RELATED PATENT APPLICATION

This application claims the benefit of Korean Patent Application No. 10-2008-0071898, filed on Jul. 23, 2008, in the Korean Intellectual Property Office, the disclosure of which is incorporated herein by reference in its entirety.

### TECHNICAL FIELD

The present invention generally relates to an image drum used in a direct type image forming apparatus, and a method of manufacturing the same.

### BACKGROUND OF RELATED ART

In an electro-photographic image forming apparatus, an electrostatic latent image is first formed on a surface of a drum. The electrostatic latent image can then be developed using a developer, such as toner, for example, to form a developed image. The developed image is then subsequently transferred onto a printing medium and it is fused on that printing medium.

In a conventional electro-photographic image forming apparatus, the entire surface of the drum is evenly charged to a constant potential. The charged surface of the drum is then exposed in a manner that is based on the image data to be formed to produce on the surface of the drum the electrostatic latent image. To produce the electrostatic latent image, a conventional image forming apparatus typically includes a photosensitive drum, a charging apparatus, and an optical scanning apparatus. In an electro-photographic image forming apparatus having the above-described structure, the charging and the exposure operations are performed in relation to the photosensitive drum, and thus, the amount of time that takes to form the image is limited by the structural characteristics of the photosensitive drum. Moreover, the size of the electro-photographic image forming apparatus is limited by the charging apparatus and/or the optical scanning apparatus. Therefore, the recent tendency towards building ever smaller devices makes the use of conventional electro-photographic image forming apparatuses less desirable.

An image forming apparatus in which the electrostatic latent image can be directly formed on the outer surface of the drum without using a charging apparatus and an optical scanning apparatus has been suggested. In a direct-type image forming apparatus, the image drum is fabricated by having multiple ring electrodes disposed on an outer circumferential surface of a cylindrical drum body.

### SUMMARY OF THE DISCLOSURE

According to an aspect of the disclosure, there is provided an image drum having a slot formed along a longitudinal direction of the drum body, multiple ring electrodes, multiple ring insulator molds, and a connection member. Each ring electrode is disposed on an outer circumferential surface of the drum body at a unique position along the longitudinal direction of the drum body and apart from an adjacent ring electrode. Each ring insulator mold is disposed between adjacent ring electrodes. The connection member includes multiple connection lines. Each connection line is electrically coupled to an associated ring electrode. At least a portion of the connection member is disposed in the slot of the drum body.

Outer surfaces of the plurality of ring electrodes and the plurality of ring insulator molds may collectively define a substantially leveled surface.

The image drum may further include an insulating layer disposed between the drum body and the plurality of ring electrodes and between the drum body and the plurality of ring insulator molds.

The insulating layer may have a plurality of exposed portions, each connection line from the plurality of connection lines of the connection member being coupled to its associated ring electrode through one of the exposed portions in the insulating layer.

The connection member may comprise a flexible circuit board or a rigid circuit board.

The image drum may further include a controlling device disposed within the drum body. The controlling device may be configured to control a potential applied to each ring electrode from the plurality of ring electrodes.

The connection member may include one or more connection boards.

An end portion of each of the one or more connection boards of the connection member may be disposed in the slot of the drum body.

Outer surfaces of the plurality of ring electrodes and the plurality of ring insulator molds may collectively define a substantially leveled surface. The image drum may further include an insulating protective layer disposed on the substantially leveled surface of the plurality of ring electrodes and the plurality of ring insulator molds.

According to another aspect of the disclosure, there is provided a method of manufacturing an image drum, which may include placing a connection member within a cylindrical drum body; forming a seed layer on the outer circumferential surface of the cylindrical drum body; forming a plurality of ring insulator molds on the outer circumferential surface of the cylindrical drum body; and forming a plurality of ring electrodes by filling conductive material between adjacent ones of the plurality of ring insulator molds. The seed layer may comprise a pattern of seed rings arranged along a longitudinal direction of the cylindrical drum body. Each of the plurality of ring insulator molds may be formed between adjacent ones of the seed rings.

Placing of the connection member within the cylindrical drum body may comprise forming a slot in the cylindrical drum body, the slot extending along the longitudinal direction of the cylindrical drum body; and inserting at least a portion of the connection member into the slot so that the connection member is supported in the slot.

The method may further include removing a portion of the connection member protruding from the slot to smooth the outer circumferential surface of the outer circumferential surface of the cylindrical drum body in the vicinity of the slot.

The method may further include coating the outer circumferential surface of the drum body with an insulating layer; and removing portions of the insulating layer so as to expose connection lines of the connection member.

The plurality of ring insulator molds may be formed of photoresist resin.

Forming of the plurality of ring electrodes may comprise filling with the conductive material up to heights of the adjacent ones of the plurality of ring insulator molds.

Forming the plurality of ring electrodes may comprise depositing the conductive material using an electroless plating process.

Forming of the plurality of ring electrodes may further comprise controlling a deposition time so as to fill the conductive material up to heights of the adjacent ones of the plurality of ring insulator molds.

Forming of the plurality of ring electrodes may comprise attaching one or more ion-type electrolyte on each of the seed rings; and depositing the conductive material using the ion-type electrolyte as a precursor.

Forming of the plurality of ring electrodes may further comprise removing impurities on the seed layer; and activating the seed layer before attaching the ion-type electrolyte on the seed rings.

The method may further comprise forming an insulating protective layer over the plurality of ring electrodes.

According to yet another aspect of the disclosure, there is provided a method of manufacturing an image drum, which may include forming a plurality of seed rings on an outer circumferential surface of a drum body; forming a plurality of ring insulators each having a first thickness; and forming a plurality of ring electrodes by depositing a conductive material on each of the plurality of seed rings between adjacent ones of the plurality of ring insulators. Each of the plurality of seed rings may be formed at a unique location along the longitudinal direction of the drum body, and may be spaced apart from adjacent ones of the plurality of seed rings. Each of the plurality of ring insulators may be formed between two adjacent ones of the plurality of seed rings. Each of the plurality of ring electrodes may have a thickness substantially same as the first thickness.

The method may further comprise forming a slot in the drum body, the slot extending along a longitudinal direction of the drum body; and disposing a connection member within the drum body through the slot. The connection member may have a plurality of connection lines exposed to an outer circumferential surface of the drum body through the slot.

The method may further comprise coating the outer circumferential surface of the drum body with an insulating layer; and defining a plurality of openings on the insulating layer. Each of the plurality of openings may correspond to respective associated one of the plurality of connection lines to expose the respective associated one of the plurality of connection lines.

Forming of the plurality of seed rings may comprise forming a conductive layer over the outer circumferential surface of the drum body; and removing portions of the conductive layer so as to leave only the produce a pattern conductive rings of the plurality of seed rings remain as remaining portions of the conductive layer. Each of the plurality of seed rings may be electrically connected to a respective corresponding one of the plurality of connection lines of the connection member.

### BRIEF DESCRIPTION OF THE DRAWINGS

Various aspects of the present disclosure will become more apparent and more readily appreciated from the following description of the embodiments, taken in conjunction with the accompanying drawings, of which:

FIG. 1 is a schematic block diagram of an image forming apparatus that uses an image drum according to an embodiment;

FIG. 2 is a schematic perspective view of an image drum according to an embodiment;

FIG. 3 is a perspective view of a connection member in the image drum of FIG. 2;

FIG. 4 is a longitudinal cross-sectional view of a connection structure between a ring electrode and the connection member in the image drum of FIG. 2;

FIG. 5 is a cross-sectional view of an image drum according to another embodiment;

FIG. 6 is a cross-sectional view of an image drum according to yet another embodiment; and

FIGS. 7A-12D are views illustrating processes in a method of manufacturing the image drum according to an embodiment.

### DETAILED DESCRIPTION OF SEVERAL EMBODIMENTS

Various aspects of the disclosure will be described more fully with reference to the accompanying drawings. In the drawings, the thicknesses of layers and regions may be exaggerated for clarity. It will also be understood that when a layer or a feature is referred to as being “on” another layer or feature, the layer or feature can be disposed directly on the other layer or feature, or there could be intervening layer(s) or feature(s) therebetween. Like reference numerals in the drawings denote like elements, and thus their description may not be repeated.

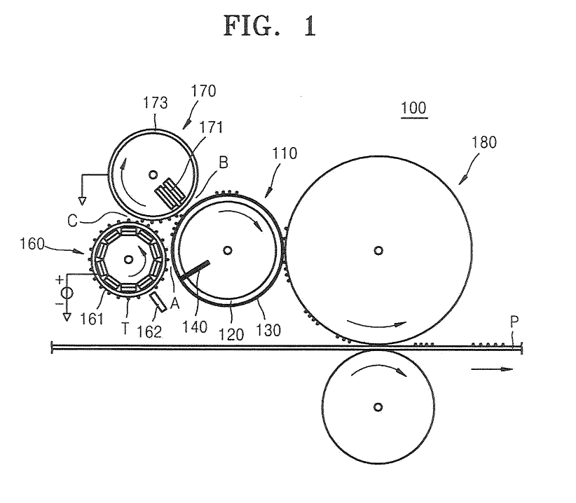

FIG. 1 is a schematic block diagram of an image forming apparatus 100 that uses an image drum 110 according to an embodiment. Referring to FIG. 1, the image forming apparatus 100 includes the image drum 110, a toner supply unit 160, a toner recovery unit 170, and an image transfer unit 180. The image drum 110 includes a drum body 120, a ring electrode portion 130 formed on an outer surface of the drum body 120, and a connection member 140. The toner supply unit 160, the toner recovery unit 170, and the image transfer unit 180 are disposed around the image drum 110. Ring electrodes (not shown), to which a voltage or potential can be independently applied, are included in the ring electrode portion 130. The structure of the image drum 110 will be described in more detail below.

The toner supply unit 160 supplies toner T from a toner storage unit (not shown) using a toner supplying roller 161. The supplied toner T is transferred from the toner supplying roller 161 to the image drum 110 while passing through a region A between the toner supplying roller 161 and the image drum 110. A regulating unit 162 is configured to regulate the amount of the toner T that is attached to a surface of the toner supplying roller 161. The toner T used in the image forming apparatus 100 has conductive and magnetic properties. The image drum 110 attracts the toner T by using an electrostatic force that is generated when a voltage is applied to the ring electrodes of the ring electrode portion 130. At least a portion of the toner T may be transferred to the toner recovery unit 170 from the image drum 110.

The toner recovery unit 170 includes a magnet cutter 171 and a rotating sleeve 173. The magnetic cutter 171 is configured to produce a magnetic force and is located in an adjacent area B between the toner recovery unit 170 and the image drum 110. The magnetic cutter 171 is configured to attract the toner T attached on the image drum 110 using the magnetic force. Because the toner T may interact with the electrostatic force of the image drum 110 and with the magnetic force of the magnet cutter 171, the toner T may remain attached on the image drum 110 or may be attracted by the magnet cutter 171 based on the relative strengths of the electrostatic force and the magnetic force. The strength of the electrostatic force varies depending on the magnitude of the voltage applied to the ring electrodes 133 of the image drum 110.

When the voltage applied to the ring electrodes in the ring electrode portion 130 is such that the voltage produces an electrostatic force having a strength that is greater than the strength of the magnetic force produced by the magnet cutter 171, the toner T remains attached to the ring electrode 133 of the image drum 110 when passing through the adjacent area B between the image drum 110 and the toner recovery unit 170. When the voltage applied to the ring electrodes in the ring electrode portion 130 is such that the voltage produces an electrostatic force having a strength that is smaller than the strength of the magnetic force of the magnet cutter 171, the toner T is attracted to the tone recovery unit 170 by the stronger magnetic force of the magnet cutter 171 when passing through the adjacent area B between the image drum 110 and the toner recovery unit 170. Thus, the image forming apparatus 100 can produce an image corresponding to an image signal on the image drum 110 by controlling the voltage that is applied to the ring electrodes in the ring electrode portion 130.

The toner T that is attracted to the magnetic cutter 171 can be returned to the toner supply unit 160 or to the toner storage unit (not shown) by a magnetic force produced around an adjacent area C between the rotating sleeve 173 of the toner recovery unit 170 and the toner supplying roller 161 of the toner supply unit 160.

The toner T that is not returned by the magnetic cutter 171, and that remains on the surface of the image drum 110, is transferred to the image transfer unit 180 from the image drum 110. The toner T transferred to the image transfer unit 180 is subsequently transferred to a printing medium 190. The printing medium 190 is then thermally treated to fix the toner T onto the printing medium 190.

The above-described image forming apparatus includes one image drum 110, one toner supply unit 160, and one toner recovery unit 170, as an example. To produce full-color images, however, multiple image drums 110, multiple toner supply units 160, and multiple toner recovery units 170 may be desirable. For example, multiple image drums 110, one for each of yellow (Y), magenta (M), cyan (Cy), and black (Bk) toners, can be disposed around an outer circumferential surface of the image transfer unit 180 such that different color toners can be applied to the same printing medium 190. Moreover, while the image transfer unit 180 is shown as a cylindrical device (e.g., a roller) in FIG. 1, the image transfer unit 180 need not be so limited. For example, the image transfer unit 180 can be implemented using a belt or other structure.

In some embodiments, a single-color image can be formed without a need for an additional image transfer unit 180 by having the printing medium 190 pass between the image drum 110 and the image transfer unit 180 and have the image be transferred from the image drum 110 directly onto the printing medium 190.

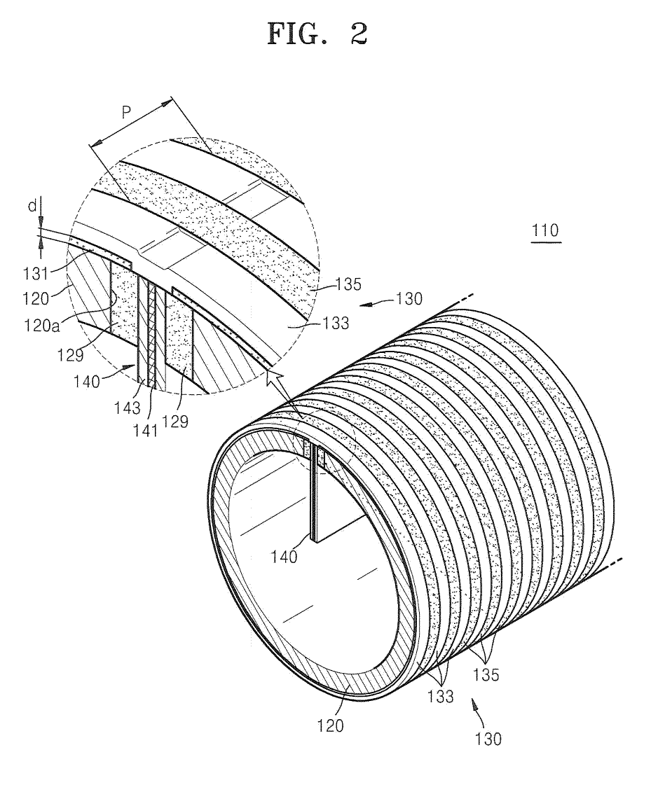

Various embodiments of the image drum 110 described above with respect to the image forming apparatus 100 shown in FIG. 1 will be described in more detail with reference to FIGS. 2-6.

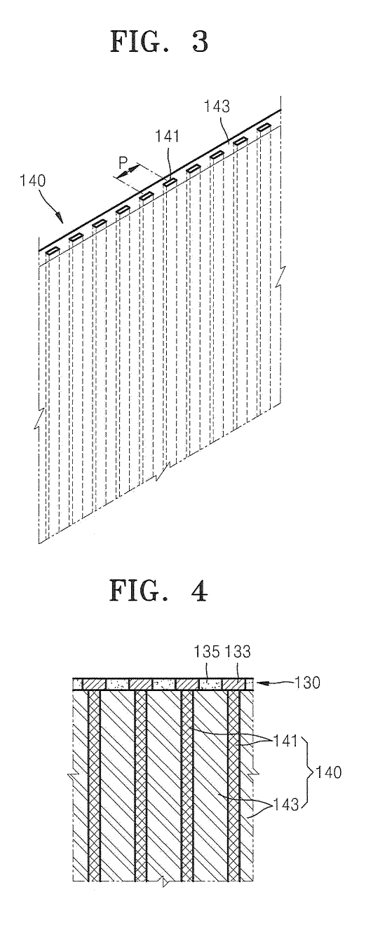

FIG. 2 is a perspective view of the image drum 110 according to an embodiment. FIG. 3 is a perspective view of a connection member in the image drum 10 of FIG. 2, and FIG. 4 is a longitudinal cross-sectional view of a connection structure between a ring electrode and a connection member in the image drum 110 of FIG. 2.

Referring to FIG. 2, the image drum 110 includes a drum body 120, a ring electrode portion 130 formed on an outer circumferential surface of the drum body 120, and a connection member 140 electrically connecting to the ring electrode portion 130.

The drum body 120 can have a cylindrical shape. The drum body 120 can have a main wall and a hollow central portion defined by an inner circumferential surface of the main wall. The drum body 120 can be rotatably disposed in the image forming apparatus 100 around the toner supply unit 160 as described above with respect to FIG. 1. The drum body 120 can be made of a metal such as aluminium, for example, or can be made of a non-metallic insulating material. A slot 120a having a predetermined width is formed in a portion of the main wall of the drum body 120 along a longitudinal direction of the drum body 120. The slot 120a includes an opening through the entire thickness of the main wall of the drum body 120, that is, the slot 120a extends from the outer circumferential surface of the drum body 120 to the inner circumferential surface of the drum body 120. When the drum body 120 is formed of the metal such as aluminium, the outer circumferential surface of the drum body 120 may be oxidized to form an insulating coating layer.

The ring electrode portion 130 includes multiple ring electrodes 133. Each of the ring electrodes 133 is arranged in a unique location along the longitudinal direction on the outer circumferential surface of the drum body 120, which according to an embodiment may be at a constant interval from one another. The ring electrode portion 130 also includes multiple ring insulator molds 135 located between the ring electrodes 133. The spacing between ring electrodes 133 can be sufficiently small to produce high-resolution images. For example, to form an image on an A4 size sheet of paper with a 600 dots-per-inch (dpi) resolution, a pitch (P) between ring electrodes 133 may be about 42.3 microns (μm). The pitch P between ring electrodes 133 and a width of each ring electrode 133 used for a particular implementation of the drum body 120 can vary depending on the resolution of the image to be formed and/or on the size of the printing medium on which the image is to be formed. In the present embodiment, the ring electrodes 133 are arranged with constant intervals, however, the spacing and/or width associated with the ring electrodes 133 need not be constant. When desirable, some or all of the ring electrodes 133 can have widths and/or can be arranged in intervals that are different from each other (e.g., non-uniform).

The ring electrodes 133 can be made of a conductive material. In some embodiments, the ring electrode 133 can be made of a metal such as copper, for example. The ring insulator molds 135 can be made of an epoxy-based resin such as SU-8, for example, or of other commonly used insulating materials. SU-8 can be used as a photoresist, and thus, a molded structure made with SU-8 through a photolithography process can be used as the ring insulator mold 135 as will be described further below.

The ring insulator molds 135 between the ring electrodes 133 can reduce the steps or surface variations that occur from the presence of the ring electrodes 133 on the outer circumferential surface of the image drum 110. The outer surface of the ring electrodes 133 and outer surface of the ring insulator molds 135 define an outer circumferential surface with a substantially leveled surface. Said differently, the ring electrode portion 130 having the ring electrodes 133 and the ring insulator molds 135 may be formed to have a substantially constant thickness, taking into consideration the processing tolerance and/or the size of toner particles. In one example, a ring electrode portion 130 having a thickness variation of about 1-2 μm can be regarded as having a substantially constant thickness when considering the pitch P between the ring electrodes 133 and/or the size of toner particles.

Because the ring insulator molds 135 reduce the steps associated with the ring electrodes 133 on the outer circumferential surface of the image drum 110, the abrasion or grinding of the surface of the ring electrodes 133, which is generally caused by repeated friction generated when the image drum 110 operates in the image forming apparatus 100, can be limited to prevent the generation of stripes on the image formed that are typically produced by the abraded areas of the ring electrodes 133. By using ring insulator molds 135, the durability and lifespan of the image drum 110 may also increase. Moreover, because the ring insulator molds 135 are placed between the ring electrodes 133, the toner T cannot be deposited in the recesses between the ring electrodes 133.

In the image drum 110 of the present embodiment, the thickness of the ring electrodes 133 can be increased because the large steps that would be associated with such thick ring electrodes 133 can be offset by using thick ring insulator molds 135. When the thickness of the ring electrodes 133 is increased, the lifespan of the image drum 110 can also increase because the effects of the abrasion of the ring electrodes 133 become less of a factor.

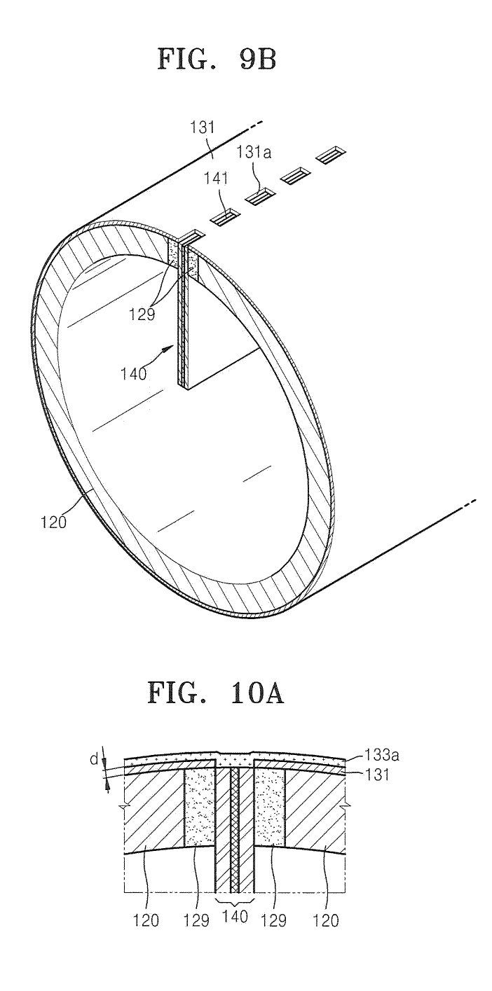

An insulating layer 131 can be disposed between the drum body 120 and the ring electrode portion 130. The insulating layer 131 can be made of an epoxy-based resin such as SU-8, for example, or of other commonly used insulating materials. A portion of the insulating layer 131 associated with a connection line 141 can be removed to expose (see FIG. 9B) the connection line 141 such that the connection line 141 can be electrically connected to its associated ring electrode 133. In another embodiment, a portion of the insulating layer 131 corresponding to the slot 120a, in which the connection member 140 is to be inserted, can be exposed. Moreover, in the present embodiment, the drum body 120 can be made of the conductive material such as aluminium, for example, and the insulating layer 131 can be formed on the outer circumferential surface of the drum body 120. In another embodiment, the drum body 120 can be made of an insulating material, in which case, the insulating layer 131 may not be necessary, and can be omitted.

The thickness of the insulating layer 131 is based on the insulating properties that may be needed. For example, when the insulating layer 131 has a thickness of 1-2 μm and is made of a commonly used insulating material, the insulating layer 131 may provide sufficient insulation.

Because a portion of the insulating layer 131 is removed to electrically connect the connection line 141 in the connection member 140 and the ring electrode 133 of the ring electrode portion 130 to each other, the boundaries of the removed portion in the insulating layer 131 may form steps, and the ring electrode 133, which is formed on the insulating layer 131 and over those boundaries, may also have steps. The effects of these steps, however, may be generally ignored because the thickness (d) of the insulating layer 131, and thus the height of the steps, is small when compared to variations in the manufacturing processes and/or the sizes of toner particles. Moreover, as described above, the portion of the insulating layer 131 that is removed car, be limited to a small portion that exposes the connection line 141, reducing the effect of the steps produced at the boundaries of the removed portion of the insulating layer 131. By limiting the amount of the insulating layer 131 that is removed, the size of the steps can be minimized and the generation of stripes on the image as a result of those steps can be prevented. This can also increase the durability and the lifespan of the image drum 110.

In some embodiments, the connection member 140 can include a flexible circuit board. In other embodiments, the connection member 140 can include a rigid circuit board.

FIG. 3 shows an example of the connection member 140. Referring to FIG. 3, the connection member 140 can include multiple connection lines 141. Each of the connection lines 141 can have a one-to-one correspondence with one of the ring electrodes 133 (see FIG. 2). The connection member 140 can include an insulating sheet 143 surrounding the connection lines 141. The insulating sheet 143 can be made of commonly used insulating materials, and need be sufficiently thin to be received in the slot 120a as shown in FIG. 2. As an example, the insulating sheet 143 can be made of a polymer having excellent electrical insulating property such as polyimide, for example, or can be made of a commonly used printed circuit board material. The connection lines 141 are separated from each other by finely spaced intervals. When constant intervals are used, a pitch P between the connection lines 141 can be the same as the pitch P between the ring electrodes 133 shown in FIG. 2. The insulating sheet 143 can include multiple insulating sheet layers, and the connection lines 141 can be disposed between several insulating sheet layers. For example, each of the connection lines 141 can be formed on an insulating sheet layer, and that insulating sheet layer can be covered by one or more insulating sheet layers. In the present embodiment, the connection lines 141 are disposed between the insulating sheet layers forming the insulating sheet 143. In some embodiments, a side of a connection line 141 may be exposed out of the side surface of the insulating sheet 143.

Referring to FIG. 4, the end portion of the connection member 140 is disposed to coincide or be leveled with the outer circumferential surface of the drum body 120, and the end of the connection line 141 can directly contact its associated ring electrode 133.

Referring back to FIG. 2, the connection member 140 can be disposed straight within the drum body 120 or can be wound within the drum body 120. In other embodiments, the connection member 140 can be folded or bent when disposed within the drum body 120.

A fixing member 129 can be disposed in the slot 120a between the connection member 140 and the inner walls of the slot 120a. The connection member 140 can be vertically inserted through the slot 120a and can be fixed to the drum body 120 at the slot 120a by the fixing member 129. The fixing member 129 can be made of a molding resin such as an epoxy molding compound (EMC), for example, or can be made of other adhesives. When desirable, the connection member 140 can be directly fitted into the slot 120a and can be fixed to the drum body 120 at the slot 120a without the need for a fixing member.

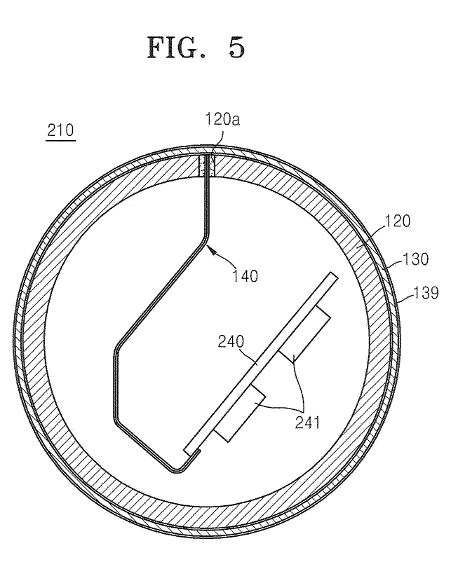

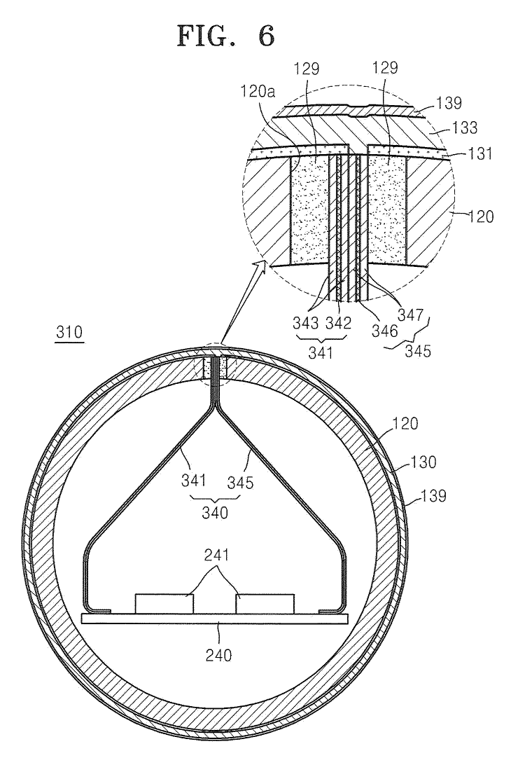

An insulating protective layer 139 (see FIGS. 5 and 6) can be formed on the outer circumferential surface of the ring electrode portion 130.

FIG. 5 is a cross-sectional view of an image drum 210 according to another embodiment. The image drum 210 includes the drum body 120 having a substantially cylindrical shape, the ring electrode portion 130 formed on the outer circumferential surface of the drum body 120, the insulating protective layer 139 covering the outer circumferential surface of the ring electrode portion 130, and the connection member 140 including multiple connection lines 141 that are electrically connected to the ring electrodes 133 in a one-to-one correspondence.

The connection member 140 may include a controlling device 241 configured to electrically control the voltage or potential that is applied to the ring electrodes 133. The connection member 140 may also include a controlling board 240 on which the controlling device 241 is disposed. Like reference numerals as those of FIGS. 2-4 denote the like elements and detailed descriptions of the elements can be omitted.

The insulating protective layer 139 protects the ring electrode portion 130, and insulates the outer portion of the ring electrodes 133 to prevent the ring electrodes 133 from directly contacting external substances such as the toner, for example.

According to an embodiment, the connection member 140 can be used to connect to the ring electrodes 133 and the controlling board 240 in the image drum 110 to form a circuit for controlling the operation of the ring electrodes 133. In this embodiment, the controlling device 241 is mounted on the controlling board 240. The controlling device 241 can include a controlling chip (for example, an application-specific integrated circuit (ASIC)) configured to control the voltage that is independently applied to each of the ring electrodes 133. The controlling board 240 can be a rigid circuit board such as a printed circuit board (PCB). The controlling board 240, however, need not be so limited.

The controlling device 241 and the controlling board 240, on which the controlling device 241 is mounted, can be fixed within the drum body 120 by an additional or different support member (not shown) in the drum body 120. When the controlling device 241 is disposed inside the drum body 120, the number of wires that may be needed to operate the image drum 210 can be reduced, and thus, any wiring problems or difficulties associated with the rotation of the image drum 210 may also be reduced. In the present embodiment, the connection member 140 and the controlling board 240 are separate elements, however, in another embodiment, the connection member 140 and the controlling board 240 can be formed integrally with each other.

FIG. 6 is a cross-sectional view of an image drum 310 according to another embodiment. The image drum 310 includes the cylindrical drum body 120, the ring electrode portion 130 formed on the outer circumferential surface of the drum body 120, the insulating protective layer 139 covering the outer circumferential surface of the ring electrode portion 130, and a connection member 340 including a first and second connection boards 341 and 345 that are electrically connected to the ring electrodes 133 of the ring electrode portion 130. A single slot 120a is formed in the drum body 120, and end portions of the first and second connection boards 341 and 345 are inserted into the slot 120a. Like reference numerals as those of FIGS. 2-5 denote the like elements, and detailed descriptions of those elements are not repeated.

The first and second connection boards 341 and 345, respectively, include first and second connection lines 342 and 346 that are electrically connected to the ring electrodes 133 of the ring electrode portion 130 in one-to-one correspondence. Also shown are insulating sheets 343 and 347 associated with the first and second connection boards 341 and 345, respectively. The first and second connection lines 342 and 346 are electrically connected to different ring electrodes 133 from each other. For example, the first and second connection boards 341 and 345 are inserted into the slot 120 so that the first and second connection lines 342 and 346 are offset from each other.

In one embodiment, the first and second connection lines 342 and 346 can be alternately connected to the ring electrodes 133 that are arranged along the longitudinal direction of the drum body 120 such that adjacent ring electrodes 133 are electrically connected to connection lines in different connection boards. When the two connection boards 341 and 345 are alternately connected to the ring electrodes 133 as described above, pitches between the connection lines in a connection board can be longer than when a single connection board is used. Longer pitches can make it easier to ensure that processing margins when making the connection lines are achieved, which can increase the durability in connections between the first and second connection boards 341 and 345 and the ring electrodes 133.

The other ends of the first and second connection boards 341 and 345 opposite the ends disposed within the slot 120a can be connected to the controlling board 240 so as to provide an electrical connection between the connection member 340 and the controlling board 240.

In the present embodiment, the connection member 340 includes the two connection boards 341 and 345, however, in other embodiments, the connection member 340 can include three or more connection boards. Moreover, in the present embodiment, the first and second connection boards 341 and 345 are inserted into the same slot 120a, however, in other embodiments, the drum body 120 can have two or more slots so that each of the first and second connection boards 341 and 345 (or any additional connection boards) is inserted into a different slot. For example, two slots may be formed at diagonally or opposite from each other in the drum body 120 such that both ends of a single rigid circuit board can be inserted into the two slots.

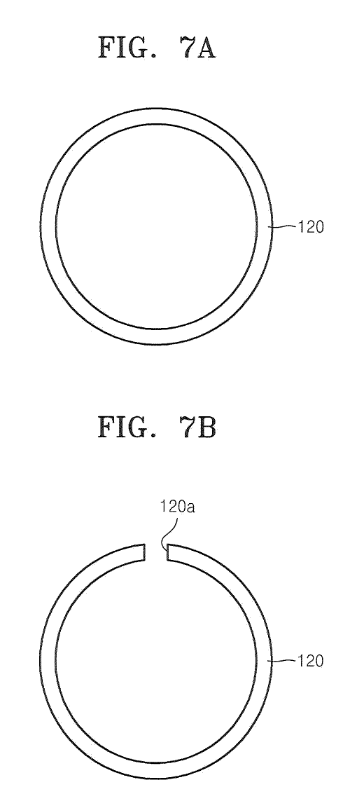

A method of manufacturing the image drum, according to an embodiment, will be described below with reference to FIGS. 7A-12D. FIGS. 7A through 12D are diagrams illustrating the processes of manufacturing the image drum according to an embodiment.

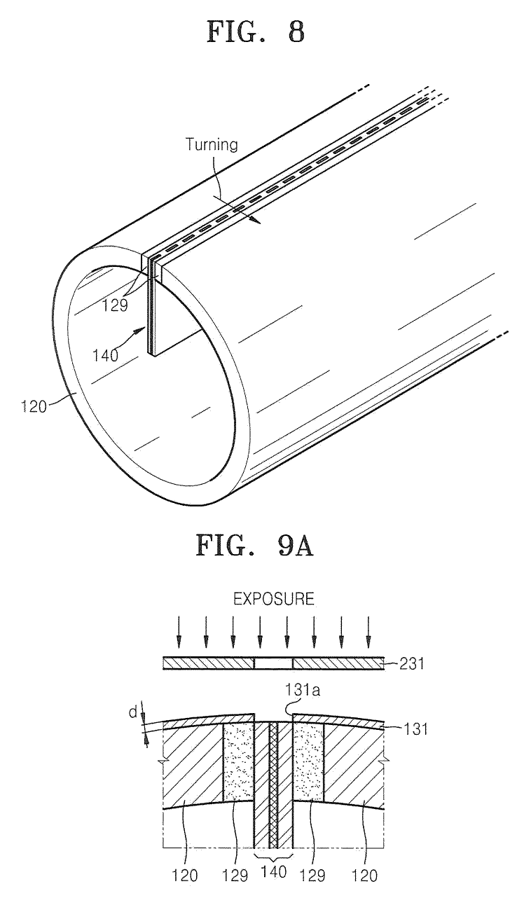

Referring to FIGS. 7A and 7B, the drum body 120 that made by forming a cylinder having a hollow center or central portion. The drum body 120 can be made of aluminium, for example. When made out of aluminium, the outer circumferential surface of the drum body 120 can be oxidized using an anodizing process. The slot 120a can be formed or defined along a longitudinal direction of the drum body 120. A width of the slot 120a may be equal or greater than a width associated with the connection member 140 as shown in FIG. 8.

Referring to FIG. 8, the connection member 140 is inserted into the slot 120a, and is fixed or attached to the drum body 120 using the fixing member 129. The fixing member 129 can be made of a molding resin such as EMC, for example. Next, a turning process is performed so that the end portion of the connection member 140 inserted in the slot 120a can coincide with the outer circumferential surface of the drum body 120. For example, the portion of the connection member 140 in the slot 120a is adjusted such that the outer circumferential surface of the drum body 120 and the end portion of the connection member 120 in the slot 120a are substantially leveled.

Referring to FIG. 9A, the outer circumferential surface of the drum body 120 is coated with the insulating layer 131. The insulating layer 131 can be made of a photoresist resin such as SU-8, for example. The thickness d of the insulating layer 131 may be, e.g., about 1 μm. An exposure process is performed using a photo mask 231. The exposure can be performed where the drum body 120 is stopped or stationary. When the insulating layer 131 is made of a positive photoresist, the photo mask 231 is patterned such that the portions of the insulating layer 131, shown by the reference numeral 131a, that coincide with the location of the connection member 140 and with the location of the connection lines 141 (see FIG. 2) are exposed. After performing the exposure, the exposed portions 131a, that is, the portions of the insulating layer 131 that coincide with the location of the connection lines 141, are removed using a developer.

FIG. 9B shows that the insulating layer 131 having the exposed portions 131a substantially match the location of the connection lines 141.

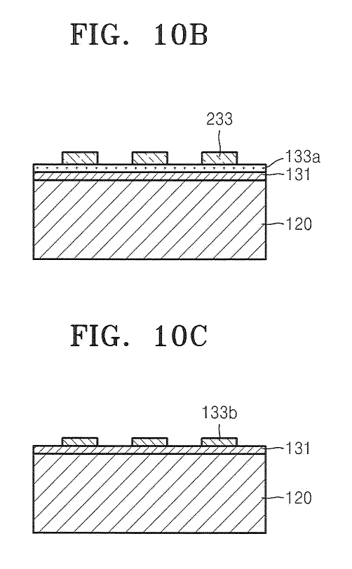

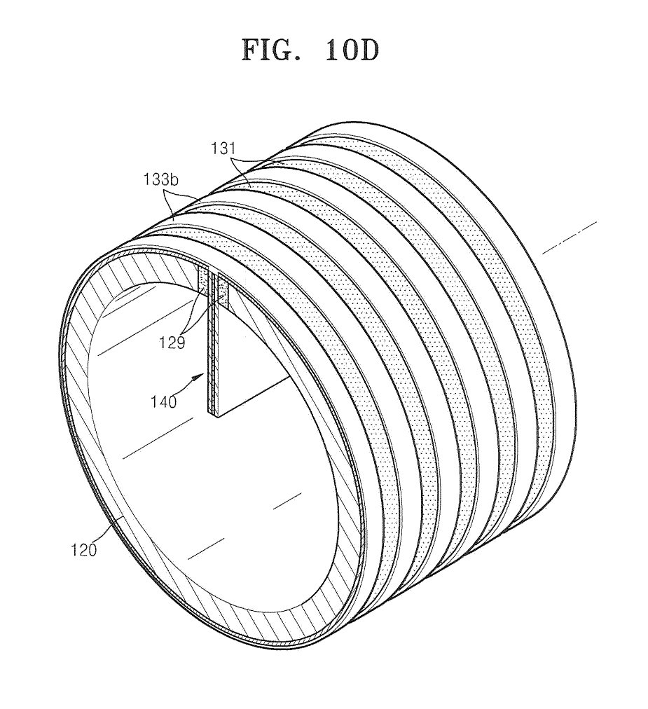

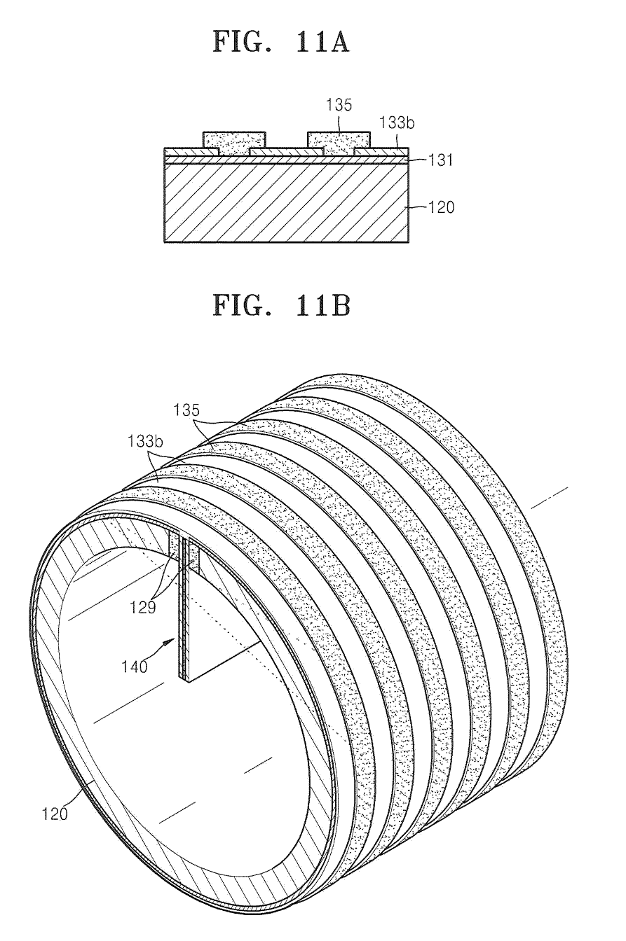

FIGS. 10A-10D illustrate processes of forming a seed layer for forming the ring electrodes 133 in the drum body 120, on which the insulating layer 131 is coated. Referring to FIGS. 10A and 10B, a seed layer 133a is disposed on the insulating layer 131 and a photoresist 233 having a seed layer pattern is formed on the seed layer 133a. In one embodiment, the photoresist 233 can be exposed using a photolithography process while rotating the drum body 120. Referring to FIG. 10C, the photoresist 233 and portions of the seed layer 133a are removed to form a seed layer pattern 133b that is used to form or make the ring electrodes 133 on the insulating layer 131. The seed layer pattern 133b includes multiple rings, each of which covers an exposed portion 131a of the insulating layer 131 associated with the location of the end portion of one of the connection lines 141 (see FIG. 9A). FIG. 10D shows the drum body 120 on which the seed layer pattern 133b has been formed to make the ring electrodes 133.

FIG. 11A illustrates the ring insulator molds 135 being formed on the drum body 120 using a photolithographic process. The ring insulator molds 135 are made between rings of the seed layer pattern 133b, that is, where the insulating layer 131 remains exposed. A thickness associated with each ring insulator mold 135 can be determined to be such that the outer circumferential surface of the ring insulator mold 135 and the outer circumferential surface of the ring electrodes 133 are substantially leveled. The ring insulator molds 135 can be formed of a photoresist resin such as SU-8, for example, and the exposure process associated with the ring insulator molds 135 can be performed while rotating the drum body 120. FIG. 11B shows that the drum body 120 on which the seed layer pattern 133b and the ring insulator molds 135 are formed.

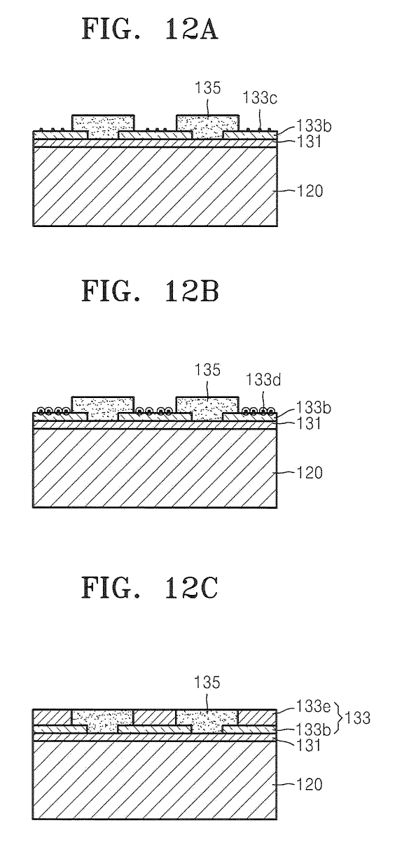

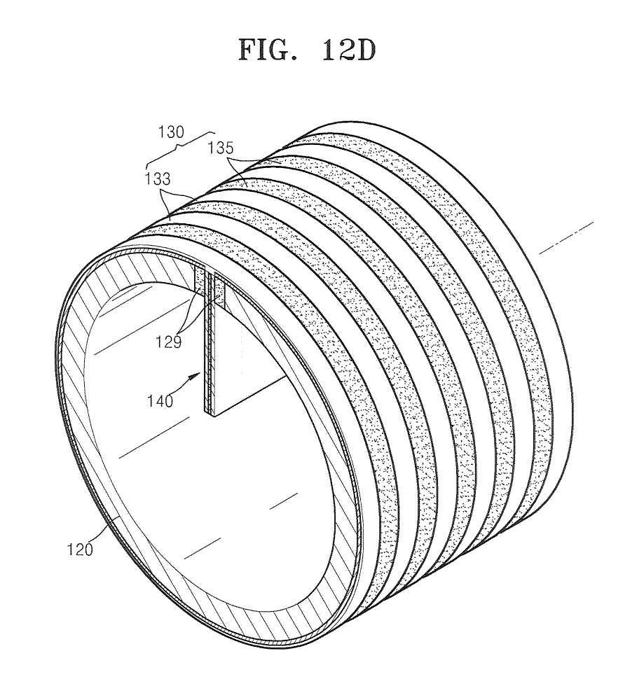

FIGS. 12A and 12B illustrate processes of forming the ring electrodes. In an embodiment, the ring electrodes are formed using an electroless plating process. Referring to FIG. 12A, an electrolyte material 133c is attached on the seed layer pattern 133b. The electrolyte material 133c can be ion-type electrolyte, for example, Pd+. The ion-type electrolyte attaches selectively onto a conductive material (e.g., metal) but does not react with a non-conductive material, unlike a colloidal electrolyte. Before attaching the electrolyte material 133c, impurities on the outer circumferential surface of the drum body 120 on which the ring insulator molds 135 are formed, are removed. A negative ionization of the surface of the seed layer 133b, that is, an activation of the seed layer 133b, can be performed to improve the wettability of the electrolyte material 133c. Referring to FIG. 12B, conductive metal 133d may be deposited using Pd as a precursor or catalyst. The conductive metal 133d may be Ni or Cu. The deposition process can be the electroless plating process described above and having a uniform depositing speed, for example. Therefore, the height of the deposited metal 133e can be matched to the height of the ring insulator molds 135 such that their outer circumferential surfaces are substantially leveled by adjusting the deposition time appropriately. FIG. 12D shows that once the ring electrodes 133 and the ring insulator molds 135 are formed, that is, once tile ring electrode portion 130 is formed, the ring electrode portion 130 provides a substantially leveled outer circumferential surface of the image drum 110. As described above, the ring insulator molds 135 are formed to a predetermined height, and then, the metal is plated and filled to the height of the ring insulator molds 135, and thus, the steps or surface variations that typically occur on the outer circumferential surface of the image drum can be reduced.

In the above embodiment, the ring electrodes 133 are formed using an electroless plating process, however, other processes can also be used. For example, an electroplating process or a deposition process can also be use to form the ring electrodes 133.

In some embodiments, an insulating protective layer (not shown) can be coated on the outer circumferential surface of the ring electrode portion 130.

While the present disclosure has been particularly shown and described with reference to exemplary embodiments thereof, it will be understood by those of ordinary skill in the art that various changes in form and details may be made therein without departing from the spirit and scope of the present disclosure as defined by the following claims.

What is claimed is:

1. An image drum, comprising:
a drum body having a slot formed along a longitudinal direction of the drum body;
a plurality of ring electrodes, each ring electrode from the plurality of ring electrodes being disposed on an outer circumferential surface of the drum body at a unique position along the longitudinal direction of the drum body, and being spaced apart from an adjacent ring electrode;
a plurality of ring insulator molds, each ring insulator mold from the plurality of ring insulator molds disposed between adjacent ring electrodes from the plurality of ring electrodes; and
a connection member including a plurality of connection lines, each connection line from the plurality of connection lines being electrically coupled to an associated ring electrode from the plurality of ring electrodes, a portion of the connection member being disposed in the slot of the drum body.

2. The image drum of claim 1, wherein outer surfaces of the plurality of ring electrodes and the plurality of ring insulator molds collectively define a substantially leveled surface.

3. The image drum of claim 1, further comprising:
an insulating layer disposed between the drum body and the plurality of ring electrodes and between the drum body and the plurality of ring insulator molds.

4. The image drum of claim 3, wherein the insulating layer has a plurality of exposed portions, each connection line from the plurality of connection lines of the connection member being coupled to its associated ring electrode through one of the exposed portions in the insulating layer.

5. The image drum of claim 1, wherein the connection member comprises a flexible circuit board or a rigid circuit board.

6. The image drum of claim 1, further comprising:
a controlling device disposed within the drum body, the controlling device configured to control a potential applied to each ring electrode from the plurality of ring electrodes.

7. The image drum of claim 1, wherein the connection member includes one or more connection boards.

8. The image drum of claim 7, wherein an end portion of each of the one or more connection boards of the connection member are disposed in the slot of the drum body.

9. The image drum of claim 1, wherein outer surfaces of the plurality of ring electrodes and the plurality of ring insulator molds collectively define a substantially leveled surface, the image drum further comprising:
an insulating protective layer disposed on the substantially leveled surface of the plurality of ring electrodes and the plurality of ring insulator molds.

10. A method of manufacturing an image drum, comprising:
placing a connection member within a cylindrical drum body;
forming a seed layer on an outer circumferential surface of the cylindrical drum body, the seed layer comprising a pattern of seed rings arranged along a longitudinal direction of the cylindrical drum body;
forming a plurality of ring insulator molds on the outer circumferential surface of the cylindrical drum body, each of the plurality of ring insulator molds being formed between adjacent ones of the seed rings; and
forming a plurality of ring electrodes by filling conductive material between adjacent ones of the plurality of ring insulator molds.

11. The method of claim 10, wherein the step of placing the connection member within the cylindrical drum body comprises:
forming a slot in the cylindrical drum body, the slot extending along the longitudinal direction of the cylindrical drum body; and
inserting at least a portion of the connection member into the slot so that the connection member is supported in the slot.

12. The method of claim 11, further comprising:
removing a portion of the connection member protruding from the slot to smooth the outer circumferential surface of the outer circumferential surface of the cylindrical drum body in the vicinity of the slot.

13. The method of claim 10, further comprising:
coating the outer circumferential surface of the drum body with an insulating layer; and
removing portions of the insulating layer so as to expose connection lines of the connection member.

14. The method of claim 10, wherein the plurality of ring insulator molds is formed of photoresist resin.

15. The method of claim 10, wherein the step of forming the plurality of ring electrodes comprises filling with the conductive material up to heights of the adjacent ones of the plurality of ring insulator molds.

16. The method of claim 10, wherein the step of forming the plurality of ring electrodes comprises depositing the conductive material using an electroless plating process.

17. The method of claim 16, wherein the step of forming the plurality of ring electrodes further comprises controlling a deposition time so as to fill the conductive material up to heights of the adjacent ones of the plurality of ring insulator molds.

18. The method of claim 16, wherein the step of forming the plurality of ring electrodes comprises:
attaching one or more ion-type electrolyte on each of the seed rings; and
depositing the conductive material using the ion-type electrolyte as a precursor.

19. The method of claim 16, wherein the step of forming the plurality of ring electrodes further comprises:
removing impurities on the seed layer; and
activating the seed layer before attaching the ion-type electrolyte on the seed rings.

20. The method of claim 10, further comprising:
forming an insulating protective layer over the plurality of ring electrodes.
